(19) United States
(12) Patent Application Publication
(10) Pub. No.: US 2011/0106590 A1
(43) Pub. Date: May 5, 2011

(54) WEIGHTED ASSESSMENT OF COGNITIVE WORKLOADS OF TEAM MEMBERS RESPONSIBLE FOR EXECUTION OF AN OPERATION

(75) Inventors: Stephen Whitlow, St. Louis Park, MN (US); Michael Christian Dorneich, Saint Paul, MN (US); Alan Cornett, Andover, MN (US)

(73) Assignee: HONEYWELL INTERNATIONAL INC., Morristown, NJ (US)

(21) Appl. No.: 12/608,852

(22) Filed: Oct. 29, 2009

(51) Int. Cl. G06Q 10/00

(52) U.S. Cl. 705/7.42

(57) ABSTRACT

A system is provided for assessing cognitive workloads of a team that is responsible for carrying out a designated operation having a plurality of execution phases. The system includes a processing architecture configured to carry out processor-executable instructions, a processor-readable medium accessible by the processing architecture, and processor-executable instructions stored on the processor-readable medium. When executed by the processor architecture, the processor-executable instructions cause the processor architecture to obtain workload data indicative of cognitive workloads of members of the team during the course of the designated operation. For each of the plurality of execution phases, the system generates weighted workload scores for participating members of the team, the weighted workload scores being generated from the workload data and from a respective set of weighting values. The respective set of weighting values includes individual weighting values for each of the participating members of the team. For each of the plurality of execution phases, the system presents the weighted workload scores for the participating members of the team in a human-interpretable format.

### TECHNICAL FIELD

Embodiments of the subject matter described herein relate generally to monitoring and assessing the functional cognitive capacity of persons carrying out a work plan, mission, operation, exercise, or the like. More particularly, embodiments of the subject matter relate to systems and methods that monitor and assess the cognitive workloads of members of a team carrying out a work plan, mission, operation, exercise, or the like.

### BACKGROUND

Traditionally, superiors assess the functional cognitive capacity of their subordinates based on direct observations, direct queries, radio communications, and/or historical performance This practice may be sufficient some of the time, but not always. As a result, one or more of the superior's subordinates may become overworked or overstressed, or conversely underworked and underutilized, which may lead to inefficiencies and ineffectiveness.

There is a trend in military and civilian operations towards distributed teams connected via voice communications. The distributed nature of the teams impedes direct, visual observation and denies the broad range of visual behavioral cues that team members can use to assess an individual's workload. Even when visual contact can be made, the culture of many task environments may prevent subordinates from revealing vulnerabilities. The subordinate may maintain an appearance of composure and competence even when they may be overcome by the stress and workload of a given situation. Furthermore, moment-to-moment variability in fatigue, stress levels, vigilance, and cognitive capacity may compromise workload predictions based on past history. Additionally, it may not be possible to use past history to predict an individual's response to task demands when task environments change.

In dynamic and enduring operations, such as those of the battlefield and first responder incidents, an individual's workload may undergo rapid and/or extreme changes within very small windows of time. Alternatively, the individual's workload may trend slowly over time to precariously low or high workload levels. Without adequate and direct monitoring of each subordinate's workload capacity, some subordinates may be tasked with more task demands than they can effectively handle, while other personnel may go underutilized to the point of boredom, which could compromise their responsiveness to subsequent task responsibilities.

Moreover, assessing the cognitive effectiveness of a distributed team, such as a small military unit, a firefighting unit, or a search-and-rescue team, is more difficult now that leaders cannot directly observe their subordinates. Overall team effectiveness cannot be accurately estimated by an “average” across individuals to arrive at a group assessment when different team member roles are more or less significant at different phases of the operation or mission. Accordingly, overloaded or distracted individuals can have a disproportionate impact on team effectiveness especially if they are in a leadership position or provide important or fundamental resources such as communication, reconnaissance, primary weapons, or the like. For example, if a soldier who is on point and responsible for navigation becomes overloaded or distracted, then this condition could have a significant adverse impact on overall team effectiveness, especially if the secondary navigator is also distracted. Likewise, platoon leaders worry most about the heavy weapons personnel, medics, and radiotelephone operators (RTOs) on most missions because the overall success of the platoon relies heavily upon those team members.

### BRIEF SUMMARY

A method is provided for assessing cognitive workloads of one or more members of a team responsible for carrying out a designated operation having a plurality of execution phases. The method obtains, with a processing architecture, processor-readable workload data that indicates cognitive workload of a member of the team during the course of the designated operation. The method also maintains a first weighting value and a second weighting value for the member of the team. The first weighting value corresponds to a first execution phase of the designated operation, and the second weighting value corresponds to a second execution phase of the designated operation. The method continues by generating, with the processing architecture, a first weighted workload score for the member of the team and a second weighted workload score for the member of the team. The first weighted workload score corresponds to the first execution phase, and the first weighted workload score is derived from the workload data and the first weighting value. The second weighted workload score corresponds to the second execution phase, and the second weighted workload score is derived from the workload data and the second weighting value.

Another method is provided for assessing cognitive workloads of one or more members of a team responsible for carrying out a designated operation having a plurality of execution phases. This method maintains, for an execution phase of the designated operation, a respective weighting value for each member of the team. The method also obtains, with a processing architecture, respective processor-readable workload data indicative of cognitive workload of each member of the team during the execution phase. The method continues by generating, with the processing architecture and for the execution phase, a respective weighted workload score for each member of the team. The respective weighted workload score for a given member of the team is influenced by the respective workload data for the given member of the team, and by the respective weighting value for the given member of the team.

Also provided is a system for assessing cognitive workloads of a team that is responsible for carrying out a designated operation having a plurality of execution phases. The system includes: a processing architecture configured to carry out processor-executable instructions; a processor-readable medium accessible by the processing architecture; and processor-executable instructions stored on the processor-readable medium. When executed by the processor architecture, the processor-executable instructions cause the processor architecture to carry out a method that involves obtaining workload data indicative of cognitive workloads of members of the team during the course of the designated operation. For each of the plurality of execution phases, the method generates weighted workload scores for participating members of the team. The weighted workload scores are generated from the workload data and from a respective set of weighting values. The respective set of weighting values includes individual weighting values for each of the participating members of the team. For each of the plurality of execution phases, the method presents the weighted workload scores for the participating members of the team in a human-interpretable format.

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a diagram that depicts members of a team carrying out an operation;

FIG. 2 is a schematic representation of an exemplary computing device that supports the cognitive workload assessment techniques described herein;

FIG. 3 is a table that includes cognitive workload data for one exemplary operation carried out by a team;

FIG. 4 is a flow chart that illustrates a cognitive workload weighting process; and

FIG. 5 is a flow chart that illustrates an exemplary embodiment of a cognitive workload assessment process.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Any implementation described herein as exemplary is not necessarily to be construed as preferred or advantageous over other implementations. Furthermore, there is no intention to be bound by any expressed or implied theory presented in the preceding technical field, background, brief summary or the following detailed description.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, processor-executed, processor-implemented, or the like. In practice, one or more processor devices can carry out the described instructions, tasks, and functions by manipulating electrical signals representing data bits at memory locations in the system memory, as well as other processing of signals.

Indeed, when implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “processor-readable medium” or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, or the like.

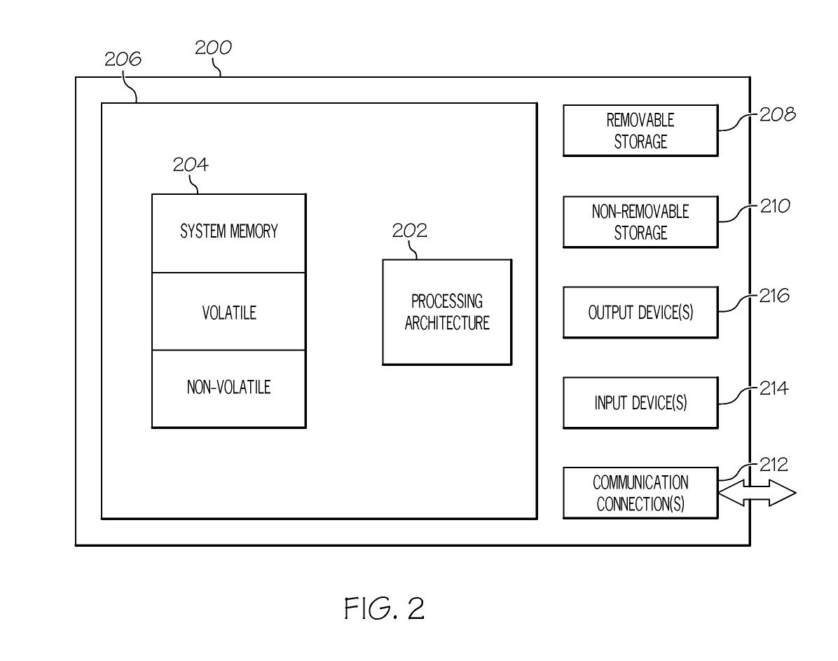

The following description may refer to elements or nodes or features being “coupled” together. As used herein, unless expressly stated otherwise, “coupled” means that one element/node/feature is directly or indirectly joined to (or directly or indirectly communicates with) another element/node/feature, and not necessarily mechanically. Thus, although the schematic shown in FIG. 2 depicts one exemplary arrangement of elements, additional intervening elements, devices, features, or components may be present in an embodiment of the depicted subject matter.

The techniques and technologies described here can be utilized to support any team-based operation where multiple team members cooperate during the execution of the operation. The term “operation” as used here generally refers to any mission, exercise, task, job, assignment, work plan, situation, undertaking, chore, drill, procedure, problem, process, course of action, approach, or the like. In this regard, “operation” is intended to encompass any or all of the terms identified above, along with any similar or equivalent terms. For example, an “operation” may be, without limitation: a military operation; a rescue mission; a law enforcement operation; a firefighting situation; a business or commercial task; a manufacturing process; a sporting event or game situation; an event that needs to be planned and executed; etc. The system described here is particularly useful for supporting operations that have distinct phases during which different team members have relatively different levels of impact, importance, or criticality.

As used herein, the term “cognitive workload” refers to the mental resources that are dedicated to current task execution. From an operational perspective, cognitive workload is defined within the context of an individual's ability to assume greater task responsibility while still successfully performing ongoing tasks. In this sense, as cognitive workload increases, an individual's ability to dedicate mental resources to additional tasks diminishes. Conversely, as cognitive workload decreases, an individual is typically able to dedicate more mental resources to additional tasks.

During certain operations, leaders might rely again and again on the same individual because they are expert in an important skill, such as breaching or medical treatment, or have proven themselves reliable in the past (i.e., that individual team member is a “go-to guy”). Over the course of extended operations, these frequently tasked individuals could become overloaded, stressed, and fatigued. Consequently, the team's effectiveness could be disproportionately impacted by the decrement in their performance, due to their important roles. The embodiments described herein provide a more complex and accurate assessment of cognitive workloads of team members, which dynamically weights the impact of each individual in accordance with their current role in the operation. Thus, the embodiments described herein generate a more accurate measure of overall team cognitive effectiveness.

U.S. Pat. No. 7,454,313 describes a methodology to support individual workload assessment via neurophysiological measures (this patent is incorporated by reference herein). The weighted cognitive workload assessment techniques described herein can leverage the technology described in U.S. Pat. No. 7,454,313 to assess each individual within a team compared to their historical baseline states. As described in more detail below, an operation can be tracked according to designated execution phases, which could be location-based, time-based, communication-pattern-based, or some combination thereof. In addition, the roles and responsibilities of the participating team members can be mapped across the duration of the operation. This enables the system to calculate moment-to-moment estimates of team effectiveness based upon an awareness of mission phase, the cognitive workloads of the team members, and the roles or responsibilities of the team members. Likewise, this system could generate a predictive measurement for future mission phases and roles by either extrapolating the trends of individual assessments or at least assuming an individual will maintain their current state if the next execution phase is temporally proximate.

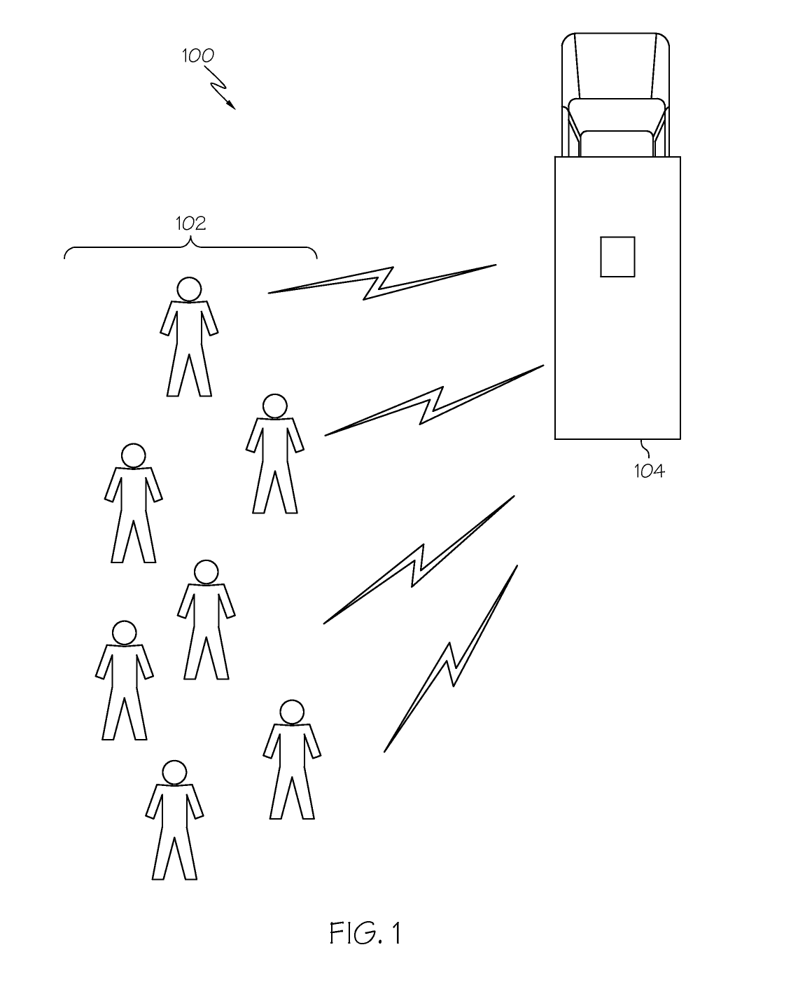

Turning now to the figures, FIG. 1 is a diagram that depicts an environment 100 with members of a team carrying out an operation. A suitably configured system for assessing the cognitive workloads of the team members 102 can be deployed in and/or near the environment 100. FIG. 1 depicts a plurality of team members 102 participating in a current execution phase of an operation. The group of team members 102 may be one or more people (adults and/or children) whose cognitive workload will be monitored. The group of team members 102 may be assigned a task to perform, which may be either a civilian or a military task. For example, the group of team members 102 may be a group of firemen assigned to fight a forest fire. As another example, the team members 102 may be an Army unit assigned to a long-range reconnaissance or building clearing mission. Although FIG. 1 depicts seven team members 102, there may be any number of team members 102 participating in the current execution phase of an operation. Moreover, the number of team members 102 may vary from one execution phase of an operation to another. Furthermore, the set of team members 102 used for an execution phase need not be static. For example, a team member John Doe could participate in only the first and last execution phases of an operation, another team member Jane Doe could participate in all execution phases of the operation, and yet another team member Mark Doe could participate in only the first and second execution phases of the operation.

Each of the team members 102 may have one or more devices located on their bodies, clothing and/or gear (e.g., helmet, gun) that transmits physiological data, contextual data, and/or any other relevant data, such as ambient temperature, to a processing unit, architecture, network, computing device, or the like. Alternatively, each of the team members 102 may have one or more devices located nearby, such as on a desk or a vehicle dashboard.

For example, a device that provides data used to estimate the cognitive workload of one or more of the team members 102 may be, without limitation: an electroencephalogram (EEG) sensor; an electrocardiogram (ECG) sensor; an electro-oculogram (EOG) sensor; an impedance pneumogram (ZPG) sensor; a galvanic skin response (GSR) sensor; a blood volume pulse (BVP) sensor; a respiration sensor; an electromyogram (EMG) sensor; a pupilometry sensor; a visual scanning sensor; a blood oxygenation sensor; a blood pressure sensor; a skin and core body temperature sensor; a near-infrared optical brain imaging sensor; a blood glucose sensor; or any other device that can sense physiological changes in a participating team member. Additionally, such a device may be, without limitation: an accelerometer; a global positioning system (GPS); a gyroscope; an eyetracker; an acoustic sensor; or any other device that can sense position, location, rate of movement, activity, or other contextual data. These devices may be commercial off-the-shelf devices or custom designed.

In certain embodiments, multiple sensors may be located on or near a team member. For example, an EEG sensor may be located on the team member's head, an ECG sensor may be located on the team member's chest, and a GPS device may be located in the team member's clothing or helmet. Alternatively, a single sensor or a single device that can sense multiple conditions may be located on or near a team member. For example, an EEG sensor, an accelerometer, and a gyroscope may be co-located within a device that is attached to the team member's head. In this example, the device may provide the roll-pitch-yaw position of the team member's in addition to providing brain wave activity.

The devices associated with the team members 102 may wirelessly transmit data to at least one computing device, processing architecture, processing unit, network, or the like. A suitable processing unit or computing system may include a display for presenting information regarding the overall team and/or the individual team members 102. Alternatively, a processing unit or computing system may transmit data via a wired or wireless connection to a display that can be monitored by one or more persons (monitors). In this regard, a monitor may be any person monitoring the group of team members 102 including, but not limited to, a leader (e.g., captain, commander, supervisor, manager) or other member of the team.

The cognitive workload assessment system also includes at least one suitably configured processing architecture, processing unit, computing device, computer system, or the like, which receives and processes the sensor data for purposes of cognitive workload assessment. For example, an appropriate processing architecture may be located in a convenient location to monitor the team members 102. For each monitored team member, the processing architecture may log sensor data over long time periods. For example, the data could be logged over temporal windows spanning days, months, and/or years. Generally, statistical models based on large samples are more representative of the phenomenon of interest and permit more accurate inferences about cognitive state.

In FIG. 1, the processing architecture is located in a truck 104, but the processing architecture may alternatively (or additionally) be located on a body, or in any type of vehicle or building that is located in range to receive the information from the sensors. For example, the processing architecture could be located within a mounted military vehicle, robotic support vehicle, first responder mobile command vehicle, or within a body worn processor. The body worn processor may be located on a person's body and/or clothing. The person may be the superior, the subordinate, or any other appropriate person for receiving the information.

FIG. 2 is a schematic representation of an exemplary computing device 200 that supports the cognitive workload assessment techniques described herein. One or more instantiations of the computing device 200 may be utilized in a deployment of a system for assessing cognitive workloads of a team. The illustrated computing device 200 is only one example of a suitable implementation, and it is not intended to suggest any limitation as to the scope of use or functionality of any practical embodiment. Other well known computing systems, environments, and/or configurations that may be suitable for use include, but are not limited to, personal computers, server computers, hand-held or laptop devices, personal digital assistants, mobile telephones, multiprocessor systems, microprocessor-based systems, programmable consumer or military grade electronics, network PCs, minicomputers, mainframe computers, distributed computing environments that include any of the above systems or devices, and the like.

The computing device 200 and certain aspects of the exemplary embodiments may be described in the general context of computer-executable instructions, such as program modules, application code, or software executed by one or more computers or other devices. Generally, program modules include routines, programs, objects, components, data structures, and/or other elements that perform particular tasks or implement particular abstract data types. Typically, the functionality of the program modules may be combined or distributed as desired in various embodiments.

The computing device 200 typically includes at least some form of tangible computer-readable or processor-readable media. In this regard, processor-readable media can be any available media that can be accessed by the computing device 200 and/or by applications executed by the computing device 200. By way of example, and not limitation, processor-readable media may comprise tangible computer storage media, which may be volatile, nonvolatile, removable, or non-removable media implemented in any method or technology for storage of information such as processor-executable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by the computing device 200.

Referring again to FIG. 2, in its most basic configuration, the computing device 200 typically includes at least one processing architecture 202 and a suitable amount of memory 204. This basic configuration is identified in FIG. 2 by reference number 206. The processing architecture 202 is preferably configured to execute and carry out processor-executable instructions associated with the cognitive workload assessment techniques, operations, and methods described herein. Accordingly, processor-readable media used by the computing device 200 is accessible by the processing architecture 202, and the processor-readable media stores the appropriate processor-executable instructions needed to support the cognitive workload assessment techniques.

Depending on the exact configuration and type of computing device 200, the memory 204 may be volatile (such as RAM), non-volatile (such as ROM, flash memory, etc.) or some combination of the two. Additionally, the computing device 200 may also have additional features/functionality. For example, the computing device 200 may also include additional storage (removable and/or non-removable) including, but not limited to, magnetic or optical disks or tape. Such additional storage is represented in FIG. 2 by the removable storage 208 and the non-removable storage 210. The memory 204, the removable storage 208, and the non-removable storage 210 are all examples of computer storage media as defined above. One or more memory devices or elements of the computing device 200 can be used to store data and information as necessary to support the various cognitive workload monitoring and assessment techniques described here. For example, a memory element could be configured to store weighting values for team members, weighted scores corresponding to cognitive workloads, and/or data that describes, defines, or is otherwise related to one or more operations being performed by the team members.

The computing device 200 may also contain communications connection(s) 212 that allow the computing device 200 to communicate with other devices, such as other networked computing devices, sensors worn or carried by the team members 102 (see FIG. 1), or the like. Depending upon the implementation, the communication connection(s) 212 may include, without limitation, suitably configured interfaces that allow the computing device 200 to communicate with a network such as the Internet, external databases, external memory devices, and the like.

The computing device 200 may also include or communicate with certain input device(s) 214 such as a keyboard, mouse or other pointing device, pen, voice input device, touch input device, etc. The computing device 200 may also include or communicate with output device(s) 216 such as a display, speakers, printer, or the like.

All of these devices are well know in the art and need not be discussed at length here. During operation of the computing device 200, an output device 216 may be utilized to present data or information in a human-interpretable output format (e.g., a display, a printed report, an electronic document, an audio/visual clip, etc.). For example, an output device 216 may generate a display, a chart, a table, or a statistical report that conveys the results of the cognitive workload assessment procedure. The computing device 200 may also be suitably configured to interpret the results, or assist in the interpretation of the results.

A system configured and deployed as described here can be used to monitor, measure, and assess the cognitive workloads of one or more members of a team that is responsible for carrying out a designated operation having a plurality of execution phases. Generally, the system uses weighting values or factors to generate weighted cognitive workload scores for the members of the team and for each execution phase of the operation. The weighting values may be based upon the roles, responsibilities, and/or seniority of the team members, the type of operation, the execution phase of the operation, historical data associated with previous operations (which may or may not be similar to the current operation), or the like.

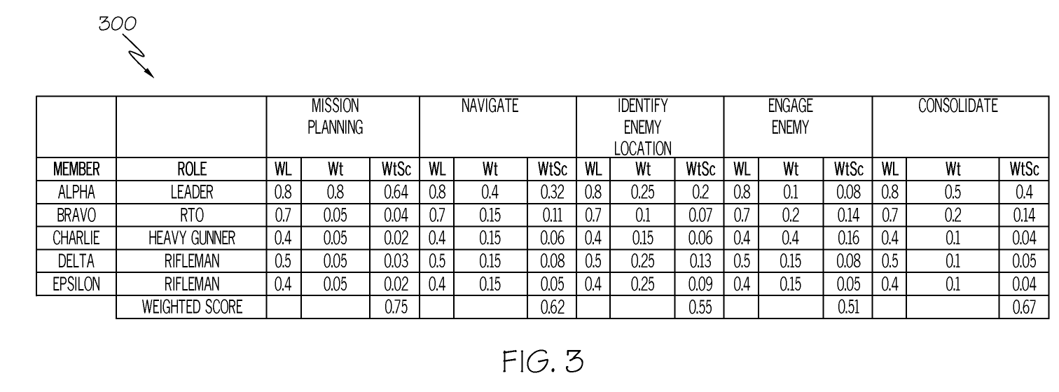

The cognitive workload assessment procedure described here can be performed in real time or near real time during the execution of the designated operation. In practice, certain aspects of the designated operation can be (and preferably are) planned, configured, and considered ahead of time. For example, it may be desirable to divide the operation into its various execution phases, assign team member roles, and determine or generate the weighting values that are used to obtain cognitive workload scores. Such planning may be performed with or without human involvement, with or without computer-based tools, etc. In certain embodiments, such planning can be performed using computer-based tools along with guidance, feedback, or advice from subject matter experts who are knowledgeable or experienced in the type of operation under consideration. In this regard, FIG. 3 is a table 300 that includes cognitive workload data for one exemplary operation carried out by a team. The table 300 represents merely one of many possible scenarios, and the particular operation illustrated in FIG. 3 does not limit or otherwise restrict the application or scope of the described subject matter.

The table 300 depicts an operation where the same team members participate in all of the execution phases. For this example, five different team members execute the operation (named Alpha, Bravo, Charlie, Delta, and Epsilon). Table 300 indicates the role or responsibility of each team member: Alpha is the team leader; Bravo is the radio telephone operator (RTO); Charlie is the heavy gunner; Delta is a rifleman; and Epsilon is a rifleman. The operation is segmented into five execution phases: mission planning; navigate; identify enemy location; engage enemy; and consolidate. For each execution phase, the table 300 includes entries for cognitive workload (WL), weighting value (Wt) and weighted workload score (WtSc), where each entry corresponds to one of the five team members. The significance of these entries is explained in more detail below. In practice, the team member assignments, the different execution phases, and the weighting values could be determined and saved in advance (i.e., before the designated operation begins). On the other hand, the cognitive workload data and the weighted scores are generated during or after the corresponding execution phase of the operation.

As another example, consider a firefighting operation. There may be a fire station attending to a fire, and the “highest” role might be that of the fire chief. An “intermediate” role might be assigned to senior firefighters, and the “lowest” role might be assigned to junior firefighters. As yet another example, a hostage situation might be divided into several stages, such as reconnaissance, negotiation, and rescue. Surveillance team members might have relatively high ranking roles during the reconnaissance phase, but relatively low ranking roles during the negotiation phase. On the other hand, mediators might have relatively high ranking roles during the negotiation phase, but relatively low ranking roles during the rescue phase.

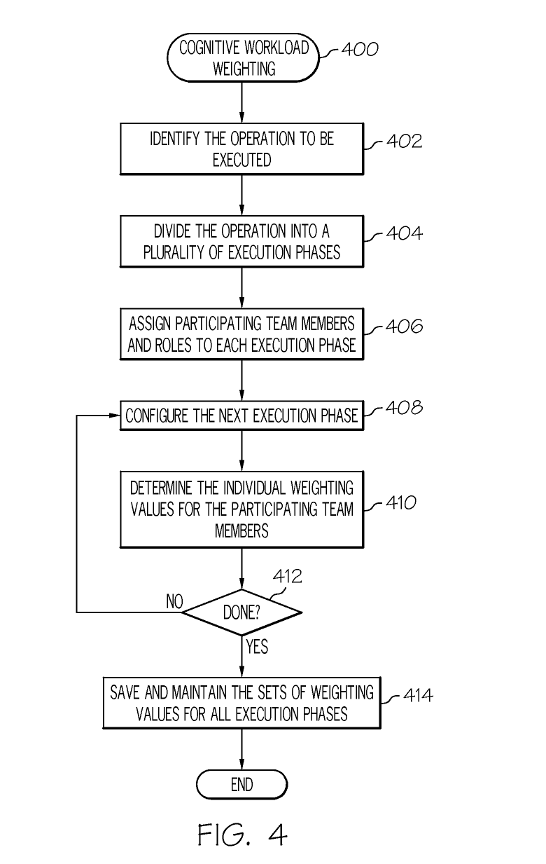

FIG. 4 is a flow chart that illustrates a cognitive workload weighting process 400. This process 400 may be performed to plan an operation and to pre-configure the cognitive workload assessment system in accordance with the planned operation. It should be appreciated that process 400 may include any number of additional or alternative tasks, the tasks shown in FIG. 4 need not be performed in the illustrated order, and process 400 may be incorporated into a more comprehensive procedure or process having additional functionality not described in detail herein. Moreover, one or more of the illustrated tasks could be omitted from a practical implementation of the process 400 (as long as the intended functionality is still maintained).

The process 400 may begin by identifying the operation to be executed (task 402). The identified operation can then be divided, decomposed, or segmented into a plurality of execution phases if necessary or desired to do so (task 404). If the operation is divided into execution phases, then the process 400 assigns participating team members and roles to each execution phase (task 406). If, however, the operation is defined as only one execution phase, then the process can assign participating team members and roles to the entire operation.

This example assumes that the operation includes a plurality of different execution phases. Accordingly, after the team members and roles have been assigned for a given execution phase, the process 400 can configure, initialize, or otherwise determine the settings for that execution phase (task 408). In this regard, the process 400 may determine the individual weighting values for the participating team members, which are to be used for that particular execution phase (task 410). If more execution phases remain (query task 412), then the process 400 can return to task 408 so that it can configure the next execution phase. In this manner, the process 400 can determine the applicable weighting values for all of the execution phases, and for all of the participating team members. If all of the execution phases have been configured, then the process 400 can save and maintain the sets of weighting values for all of the execution phases (task 414). In practice, the weighting values can be stored in one or more memory elements of the system, and the system can store a respective weighting value for each possible combination of a participating member of the team and an execution phase of the designated operation. These stored weighting values can be accessed or retrieved by the system while the operation is taking place such that the cognitive workloads of the participating team members can be calculated based on the stored weighting values.

Referring again to FIG. 3, the table 300 illustrates how different weighting values can be maintained for different team members and/or for different execution phases of the designated operation. In this regard, the system could maintain different weighting values (for a given member of the team) across the plurality of execution phases. For this particular example, the system maintains five weighting values for each team member, where each weighting value corresponds to one of the five execution phases. In certain embodiments, the weighting values for a given team member are independent and need not be correlated. Therefore, any two weighting values (for two different execution phases) for a given team member may be the same or different. In other embodiments, the weighting values for a given team member may be correlated or otherwise dependent on one another. In yet other embodiments, the weighting values for a given team member may be equal across the different execution phases. For the embodiment depicted in FIG. 3, the weighting values for the team member Alpha are as follows: 0.8 for the mission planning phase; 0.4 for the navigate phase; 0.25 for the identify enemy location phase; 0.1 for the engage enemy phase; and 0.5 for the consolidate phase. The table 300 also includes entries for the weighting values for all other team members.

For any given execution phase, the team will include a number (N) of members (N is an integer greater than one in this example). For any given execution phase, therefore, the system maintains a respective set of N weighting values, where each set of weighting values includes an individual weighting value for each member of the team participating in that execution phase. Although the value of N may vary from one execution phase to another, the example described here assumes that N remains constant and equal to five throughout the operation. For this particular embodiment, the sum of the N weighting values (for any execution phase) is equal to one. In other embodiments, the sum of the weighting values for an execution phase may be more or less than one. In yet other embodiments, the weighting values for an execution phase could be related to one another in a manner other than an additive sum.

The weighting values for an execution phase are indicative of the different roles, responsibilities, and/or other characteristics of the respective team members. For example, the weighting values may represent, indicate, or correspond to a measure of significance or importance of the team members to the given execution phase. Alternatively (or additionally), the weighting values may be based upon the role status, stature, ranking, or seniority of the team members, relative to one another. Alternatively (or additionally), the weighting values may represent, indicate, or correspond to a measure of sensitivity of success of the designated operation (or the given execution phase of the operation) to cognitive workloads of the participating members of the team.

Using the table 300 as an example, for the mission planning phase the team member Alpha has the highest weighting value (0.8, versus 0.05 for all other team members), due to Alpha's designated role as leader of the team. This relatively high weighting value indicates Alpha's relative importance to the mission planning phase. The relatively high weighting value represents Alpha's value to the mission planning phase for purposes of team effectiveness. Accordingly, Alpha's cognitive workload status has more of an impact on the overall effectiveness of the team during the mission planning phase. In contrast, during the engage enemy phase the team member Charlie has the highest weighting value (0.4) and Alpha has the lowest weighting value (0.1). This is indicative of Alpha's diminished importance or significance during the engage enemy phase, and Charlie's increased importance or significance during the engage enemy phase (due to Charlie's role as the heavy gunner). Consequently, a high cognitive workload for

Alpha during the engage enemy phase may not have as much of a negative impact as a high cognitive workload for Charlie during the engage enemy phase. In other words, the team's effectiveness and success during the engage enemy phase rely more on Charlie than any other member of the team.

Although the scenario described above with reference to FIG. 3 presumes that the various weighting values will remain fixed during the operation, variable or dynamically updateable weighting values could be utilized in certain embodiments. For example, a weighting value for a team member during a given execution phase might be revised or adjusted in response to the current status of the operation, situational awareness parameters, the monitored workload data, and/or other characteristics or data associated with the operation or the team members. Indeed, the predetermined and preconfigured weighting values could be used as initial values that are thereafter updated and adjusted as needed.

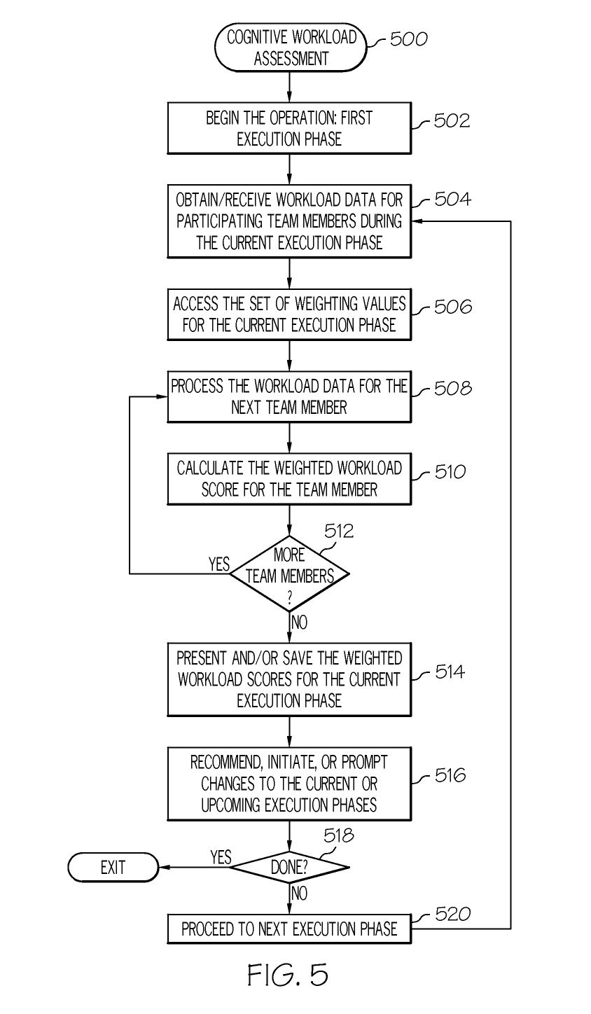

Monitored or measured cognitive workloads of members of a team can be weighted in the manner described here to provide an accurate assessment of how the cognitive workloads might impact the operation. In this regard, FIG. 5 is a flow chart that illustrates an exemplary embodiment of a cognitive workload assessment process 500 that could be performed by a system configured as described herein. The various tasks performed in connection with process 500 may be performed by software, hardware, firmware, or any combination thereof. For illustrative purposes, the following description of process 500 may refer to elements mentioned above in connection with FIGS. 1-3. In practice, portions of process 500 may be performed by different elements of the described system, e.g., a sensor, a processing architecture, a processor-executable program, a computing device, or the like. It should be appreciated that process 500 may include any number of additional or alternative tasks, the tasks shown in FIG. 5 need not be performed in the illustrated order, and process 500 may be incorporated into a more comprehensive procedure or process having additional functionality not described in detail herein. Moreover, one or more of the illustrated tasks could be omitted from a practical implementation of the process 500 (as long as the intended functionality is still maintained).

This example assumes that an operation has already been planned and initialized in accordance with process 400 (described above). Thus, the process 500 may begin when the designated operation begins (task 502). Accordingly, the process 500 assumes that the members of the team have started the first execution phase of the operation. During the course of the first execution phase of the designated operation, the process 500 obtains or receives processor-readable workload data for the members of the team that are participating in the first execution phase (task 504). In certain embodiments, a remote or centralized processing architecture obtains and processes the workload data, which indicates the cognitive workloads of each participating member of the team. In this regard, the processing architecture could receive workload data that has already been calculated and/or derived from raw sensor data, or it could receive raw sensor data and perform processing and analysis of the raw sensor data to arrive at the workload data. In certain embodiments, the system leverages the workload monitoring technology and approach described in U.S. Pat. No. 7,454,313, although other techniques or methodologies could be utilized.

The workload data for each participating team member can be obtained in real time and in a dynamic manner during the course of the first execution phase, it could be averaged for the first execution phase, or it could be intermittently calculated at certain times during the first execution phase. Accordingly, the workload data shown in FIG. 3 for the mission planning phase (i.e., the first execution phase of the operation) could represent a snapshot in time during the mission planning phase, an average value for the mission planning phase, a maximum value for the mission planning phase, or the like. The cognitive workload assessment system may use any suitable scale, range, or reference unit for the workload data. Although not required, this embodiment assumes that any individual workload score will be within the range of 0.0 to 1.0, where a score of 1.0 indicates the maximum cognitive workload. For this example, the team member Alpha has a raw, original, or non-weighted workload score of 0.8, the team member Bravo has a raw, original, or non-weighted workload score of 0.7, the team member Charlie has a raw, original, or non-weighted workload score of 0.4, the team member Delta has a raw, original, or non-weighted workload score of 0.5, and the team member Epsilon has a raw, original, or non-weighted workload score of 0.4. Therefore, the raw workload data indicates that Alpha is experiencing a relatively high cognitive workload, while Charlie and Epsilon are experiencing relatively low cognitive workloads, for the mission planning phase.

Referring back to FIG. 5, the process 500 can determine or otherwise identify the current execution phase and access the respective set of weighting values that correspond to the current execution phase (task 506). As mentioned previously with reference to the process 400, the set of weighting factors could be predetermined and stored in a memory element of the host system. The process 500 may continue by analyzing or otherwise processing the workload data for the next team member (task 508). In this regard, the process 500 can calculate, derive, or generate a weighted workload score for a team member (task 510). This weighted workload score will correspond to the first execution phase, and it will be derived from the original or unadjusted workload score and the weighting value for the team member. This weighted workload score will therefore be influenced by the identity or role of the team member, the original or non-weighted cognitive workload score of the team member, the weighting value, and the present execution phase of the operation. Task 510 can compute or calculate the weighted workload score using an appropriate formula, expression, algorithm, or routine. Although not required, this embodiment generates the weighted workload score by multiplying the original non-weighted workload score by the appropriate weighting value.

If data for more team members remains to be processed (query task 512), then the process 500 can return to task 508 to consider the next team member. If query task 512 determines that all of the team members have been considered for the current execution phase of the operation, then the process 500 can proceed to a task 514. For this embodiment, task 514 presents and/or saves the weighted workload scores for the current execution phase. Depending upon the implementation, task 514 might display the weighted workload scores in an appropriate human-interpretable format on a display element, e.g., a graph, a table (such as the table 300 shown in FIG. 3), a chart, a report, or the like. Such a display may render and display the weighted workload scores themselves in an alphanumeric format and/or display other graphical indicia that represents the weighted workload scores. In certain embodiments, task 514 might print a human-readable report, chart, graph, or table that contains the weighted workload scores. The process 500 may also calculate a total weighted score for the execution phase of the designated operation, where the total weighted score is calculated from the individual weighted workload scores. As one simple example, the total weighted score for the first execution phase could be calculated as a sum of the individual weighted workload scores.

For the example depicted in FIG. 3, the weighted workload score for Alpha during the mission planning phase is 0.64, the weighted workload score for Bravo during the mission planning phase is 0.04, the weighted workload score for Charlie during the mission planning phase is 0.02, the weighted workload score for Delta during the mission planning phase is 0.03, and the weighted workload score for Epsilon during the mission planning phase is 0.02. Thus, the total weighted score for the mission planning phase is 0.75. Notably, the weighted workload scores are influenced by the weighting values, which in turn are influenced by the contextual significance, importance, or criticality of the individual team members with respect to the mission planning phase. In other words, the weighted workload scores indicate the cognitive workloads of the team members in a manner that accurately reflects how those workloads might actually impact the effectiveness and/or success of the mission planning phase and/or the overall operation.

During or after completion of the first execution phase of the operation, the process 500 may recommend, initiate, or prompt one or more changes to the current or upcoming execution phases (task 516), where such changes are determined, guided, or otherwise influenced at least in part by the original non-weighted workload scores and/or the weighted workload scores. In a practical deployment, task 516 might be fully or partially automated, or it might be fully or partially performed with the assistance of a human operator, a technician, a commander, or other person. Task 516 enables the designated operation to be modified or revised if necessary to reflect dynamic and potentially ongoing cognitive workload fluctuations in one or more of the participating team members. For example, if the weighted workload score of a team member is on the high side, then task 516 could recommend a course of action or strategy that will remove that team member from the operation (temporarily or permanently), alleviate some of the cognitive burden on that team member, stop execution of the operation for a period of time, etc.

If the designated operation has been fully executed (query task 518), then the process 500 can exit. Otherwise, the process 500 can proceed to the next execution phase (task 520). For this example, the next execution phase will be the second phase (i.e., the navigate phase shown in FIG. 3). In certain embodiments, the cognitive assessment system may be suitably configured to automatically respond to the current status of the operation and, for example, re-enter the process 500 at task 504. This will enable the process 500 to continue obtaining the workload data for the next execution phase, which in turn can be processed in the manner described above for the first execution phase. A portion of the process 500 can be iteratively performed in this manner to obtain the weighted workload scores for each participating team member and for each of the various execution phases. The example depicted in FIG. 3 shows the overall results of an operation. As shown in the table 300, each team member has a respective unadjusted workload score and a respective weighted workload score for each execution phase. For this example, the total weighted score for the mission planning phase is 0.75, the total weighted score for the navigate phase is 0.62, the total weighted score for the identify enemy location phase is 0.55, the total weighted score for the engage enemy phase is 0.51, and the total weighted score for the consolidate phase is 0.67. These total weighted scores provide an indicator of the relative cognitive workload of the team during the course of the operation.

While at least one exemplary embodiment has been presented in the foregoing detailed description, it should be appreciated that a vast number of variations exist. It should also be appreciated that the exemplary embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing this patent application.

What is claimed is:

1. A method for assessing cognitive workloads of one or more members of a team responsible for carrying out a designated operation having a plurality of execution phases, the method comprising:
obtaining, with a processing architecture, processor-readable workload data that indicates cognitive workload of a member of the team during the course of the designated operation;
maintaining a first weighting value and a second weighting value for the member of the team, the first weighting value corresponding to a first execution phase of the designated operation, and the second weighting value corresponding to a second execution phase of the designated operation;
generating, with the processing architecture, a first weighted workload score for the member of the team, the first weighted workload score corresponding to the first execution phase, and the first weighted workload score being derived from the workload data and the first weighting value; and
generating, with the processing architecture, a second weighted workload score for the member of the team, the second weighted workload score corresponding to the second execution phase, and the second weighted workload score being derived from the workload data and the second weighting value.

2. The method of claim 1, wherein the first weighting value is different than the second weighting value.

3. The method of claim 1, further comprising presenting the first weighted workload score and the second weighted workload score in a human-interpretable format.

4. The method of claim 3, wherein the presenting step comprises displaying the first weighted workload score and the second weighted workload score on a display element.

5. The method of claim 3, wherein the presenting step comprises displaying graphical indicia on a display element, the graphical indicia representing the first weighted workload score and the second weighted workload score.

6. The method of claim 3, wherein the presenting step comprises printing a report that contains the first weighted workload score and the second weighted workload score.

7. The method of claim 1, wherein:
generating the first weighted workload score comprises calculating the first weighted workload score from the first weighting value and from a first portion of the workload data that corresponds to the first execution phase; and
generating the second weighted workload score comprises calculating the second weighted workload score from the second weighting value and from a second portion of the workload data that corresponds to the second execution phase.

8. The method of claim 1, wherein:
the first weighting value represents a first measure of significance of the member of the team to the first execution phase, relative to other members of the team; and
the second weighting value represents a second measure of significance of the member of the team to the second execution phase, relative to other members of the team.

9. The method of claim 1, wherein the first weighting value and the second weighting value are based upon a role status of the member of the team, relative to other members of the team.

10. A method for assessing cognitive workloads of one or more members of a team responsible for carrying out a designated operation having a plurality of execution phases, the method comprising:
maintaining, for an execution phase of the designated operation, a respective weighting value for each member of the team;
obtaining, with a processing architecture, respective processor-readable workload data indicative of cognitive workload of each member of the team during the execution phase; and
generating, with the processing architecture and for the execution phase, a respective weighted workload score for each member of the team, wherein the respective weighted workload score for a given member of the team is influenced by the respective workload data for the given member of the team, and by the respective weighting value for the given member of the team.

11. The method of claim 10, wherein:
during the execution phase, the team includes N members, where N is an integer greater than one;
the maintaining step maintains N weighting values for the execution phase; and
the sum of the N weighting values equals one.

12. The method of claim 10, further comprising presenting the respective weighted workload score for each member of the team in a human-interpretable format.

13. The method of claim 10, wherein each weighting value represents a measure of importance of its respective member of the team to the execution phase, relative to other members of the team.

14. The method of claim 10, wherein each weighting value is indicative of a role status of its respective member of the team, relative to other members of the team.

15. The method of claim 10, wherein:
for each of the plurality of execution phases, the maintaining step maintains a respective set of weighting values; and
each set of weighting values comprises an individual weighting value for each member of the team participating in the respective execution phase.

16. The method of claim 15, further comprising:
determining a current execution phase of the designated operation; and
accessing the respective set of weighting values corresponding to the current execution phase.

17. A system for assessing cognitive workloads of a team that is responsible for carrying out a designated operation having a plurality of execution phases, the system comprising:
a processing architecture configured to carry out processor-executable instructions;
a processor-readable medium accessible by the processing architecture; and
processor-executable instructions stored on the processor-readable medium, wherein, when executed by the processor architecture, the processor-executable instructions cause the processor architecture to carry out a method comprising:
obtaining workload data indicative of cognitive workloads of members of the team during the course of the designated operation;
for each of the plurality of execution phases, generating weighted workload scores for participating members of the team, the weighted workload scores being generated from the workload data and from a respective set of weighting values, wherein the respective set of weighting values includes individual weighting values for each of the participating members of the team; and
for each of the plurality of execution phases, presenting the weighted workload scores for the participating members of the team in a human-interpretable format.

18. The system of claim 17, wherein:
for each of the plurality of execution phases, the set of weighting values correspond to a ranking of the participating members of the team; and
the ranking indicates relative sensitivity of success of the designated operation to cognitive workloads of the participating members of the team.

19. The system of claim 17, further comprising a memory element accessible by the processing architecture, wherein the memory element is configured to store a respective weighting value for each combination of a participating member of the team and an execution phase of the designated operation.

20. The system of claim 17, wherein:
when executed by the processor architecture, the processor-executable instructions cause the processor architecture to calculate a total weighted score for a current execution phase of the designated operation; and
the total weighted score is calculated from the weighted workload scores for the current execution phase.
